(19) United States
(12) Patent Application Publication
(10) Pub. No.: US 2014/0042006 A1
(43) Pub. Date: Feb. 13, 2014

(54) MICROSWITCH ENDURING MORE CYCLES OF PRESSING ACTIVITIES

(71) Applicants: Ching-Hsin Lin, New Taipei City (TW); King-Long Lee, New Taipei City (TW)

(72) Inventors: Ching-Hsin Lin, New Taipei City (TW); King-Long Lee, New Taipei City (TW)

(21) Appl. No.: 13/584,294

(22) Filed: Aug. 13, 2012

(51) Int. Cl. H01H 1/26

(52) U.S. Cl. 200/535

(57) ABSTRACT

A microswitch comprises an accommodation room thereinside, a common terminal, an NC terminal and an NO terminal that are extended from the accommodation room, and a pressing element. The accommodation room further holds an operating element and an elastic element. The operating element has a pressed member located at one side of the common terminal and compressed by the pressing element, and a conduction member located at another side of the common terminal and interposed between the NC terminal and NO terminal. The elastic element is arranged between the common terminal and the conduction member, and has a first fixing portion coupled to the common terminal and a second fixing portion coupled to the conduction member. The operating element is normally supported by the elastic element to contact the NC terminal and pushed down by the pressing element to disconnect from the NC terminal and contact the NO terminal.

### FIELD OF THE INVENTION

The present invention relates to a durable microswitch, particularly to microswitch that applies to electronic devices for generating signals and endures more cycles of pressing activities.

### BACKGROUND OF THE INVENTION

Generally speaking, the components of an electronic device are mainly switches. With advance of science and technology, electronic devices (such as the mouse) trend to be miniaturized, and the switches thereof are thus miniaturized too. Therefore, various microswitches have been developed for miniaturized electronics.

For example, China patents of Nos. CN201060767, CN201327785 and CN201532881 disclosed microswitches each having a common terminal, an NC (normally-closed) terminal and an NO (normally-open) terminal. The common terminal connects with an elastic element, and the elastic element normally contacts the NC terminal. When the pressing element of the microswitch is pressed down, the elastic element is pushed down to contact the NO terminal. Thereby, the electronic device is switched among different circuits to generate different signals. In each of the abovementioned prior art microswitches, the elastic elements may have three components—the left one, the middle one and the right one, wherein the left and right ones are transversely interrupted and electrically connected with the common terminal, and wherein the middle one provides elastic force to prop up the elastic element.

The abovementioned prior art microswitches can indeed switch circuits. However, it is only the middle component that provides elastic force and counteracts downward force. After long time usage, the elastic element is likely to fatigue and fracture because of bending up and down repeatedly. Thus, the microswitch fails to switch circuits.

### SUMMARY OF THE INVENTION

The primary objective of the present invention is to overcome the abovementioned problem via distributing stress of elastic elements, whereby to prevent elastic elements from being fractured by long time usage and prolong the service life of elastic elements.

To achieve the above-mentioned objective, the present invention proposes a microswitch enduring more cycles of pressing activities, which comprises a casing having an accommodation room, a common terminal, an NC (normally-closed) terminal and an NO (normally-open) terminal that are extended from the accommodation room, and a pressing element able to move up and down. The microswitch further comprises an operating element and an elastic element, which are arranged in the accommodation room. The operating element has a holding hole to hold the common terminal, a pressed member located at one side of the common terminal and compressed by the pressing element, a conduction member located at another side of the common terminal and interposed between the NC terminal and the NO terminal, two connection ribs connecting the pressed member with the conduction member, and an extension member extending from the pressed member toward the common terminal. The elastic element is arranged between the common terminal and the conduction member, and has a first fixing portion coupled to the common terminal and a second fixing portion coupled to the conduction member. Thereby, the operating element is normally supported by the elastic element to contact the NC terminal and pushed down by the pressing element to disconnect from the NC terminal and contact the NO terminal.

In one embodiment, the microswitch of the present invention further comprises a spring propping up the pressed member. The pressed member is interposed between the pressing element and the spring. Two support plates are formed via respectively bending the two connection ribs, enhancing the strength of the operating element. The common terminal has a fixing hole to fix the first fixing portion of the elastic element and one end of the extension member. The first and second fixing portions of the elastic element are latch hooks able to hook the common terminal and the conduction member. Via the abovementioned technical scheme, the present invention enables the operating element to endure more cycles of pressing activities and prolongs the service life of the microswitch.

### BRIEF DESCRIPTION OF THE DRAWINGS

FIG. 1 is an exploded view of a microswitch according to one embodiment of the present invention;

FIG. 2 is another exploded view of a microswitch according to one embodiment of the present invention;

FIG. 3A and FIG. 3B are diagrams schematically the operation of a microswitch according to one embodiment of the present invention.

### DETAILED DESCRIPTION OF THE PREFERRED EMBODIMENTS

The technical contents of the present invention are described in detail in cooperation with drawings below.

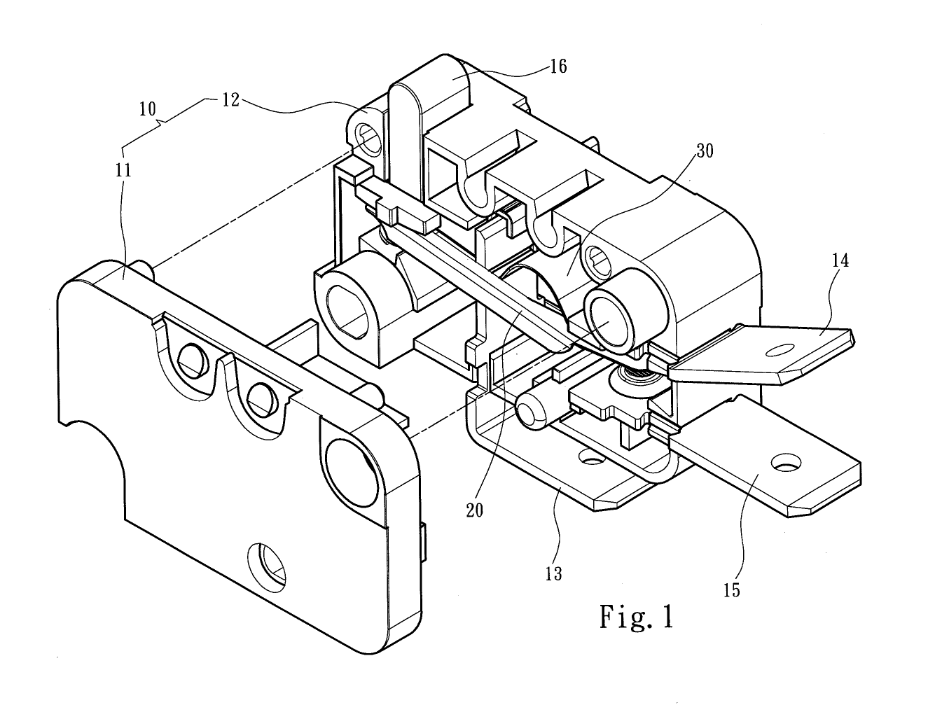

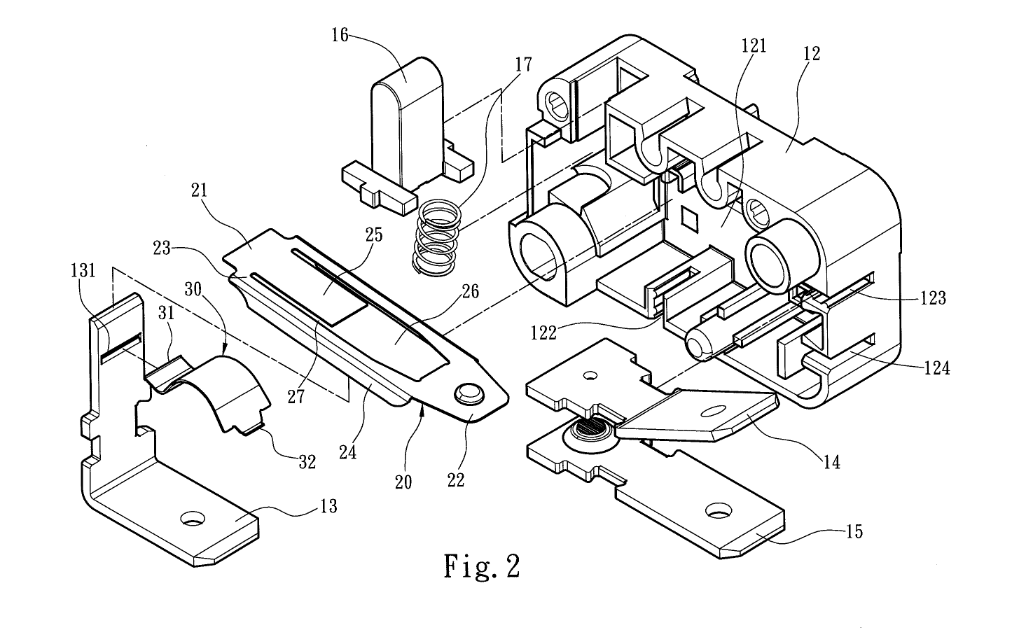

The present invention discloses a microswitch enduring more cycles of pressing activities. Refer to FIG. 1 and FIG. 2. The durable microswitch of the present invention comprises a casing 10, an operating element 20 and an elastic element 30. The casing 10 includes a base 12 and a lid 11 to cover the base 12. The base 12 has an accommodation room 121 thereinside and a first through-hole 122 at one side thereof to hold a common terminal 13 extended from the accommodation room 121. The base 12 also has a second through-hole 123 and a third through-hole 124 at another side thereof to hold respectively an NC (normally-closed) terminal 14 and an NO (normally-open) terminal 15 that are extended from the accommodation room 121. A pressing element 16 able to move up and down is also arranged inside the base 12.

The operating element 20, the elastic element 30, and a spring 17 are also arranged inside the accommodation room 121. The operating element 20 is an elastic metal plate and has a holding hole 26 to hold the common terminal 13. On one side of the common terminal 13, the operating element 20 has a pressed member 21 corresponding to the pressing element 16. On another side of the common terminal 13, the operating element 20 has a conduction member 22 corresponding to and between the NC terminal 14 and the NO terminal 15. The operating element 20 also has two connection ribs 23 connecting the pressed member 21 and the conduction member 22. Two support plates 24 are respectively extended downward from two outer sides of the connection ribs 23, enhancing the strength of the operating element 20. The support pates 24 are formed via bending the outer sides of the connection ribs 23 and integral with the connection ribs 23. An extension member 25 extends from the pressed member 21 toward the holding hole 26. One end of the extension member 25 is inserted into a fixing hole 131 of the common terminal 13. A slot 27 is formed between the extension member 25 and one of the connection ribs 23.

The elastic element 30 is an arc-like elastic metal plate and arranged between the common terminal 13 and the conduction member 22. As shown in FIG. 2, the middle section of the elastic element 30 has an arcuate shape, and two ends thereof are respectively a first fixing portion 31 and a second fixing portion 32. The first and second fixing portions 31 and 32 are latch hooks. The first fixing portion 31 is inserted into the fixing hole 131 of the common terminal 13. The second fixing portion 32 is coupled to the conduction member 22 of the operating element 20. Thereby, the operating element 20 is electrically connected with the common terminal 13. The spring 17 is arranged below the operating element 20. The pressed member 21 is interposed between the pressing element 16 and the spring 17. Thereby, the spring 17 props up the pressed member 21. Thus is completed the description of the main architecture of the present invention.

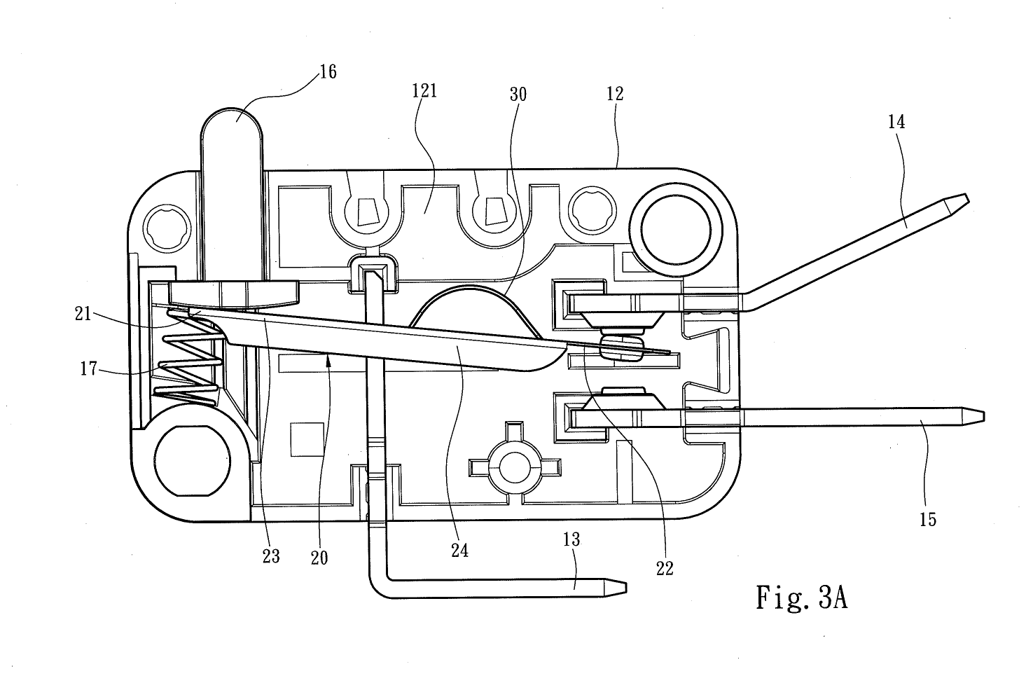

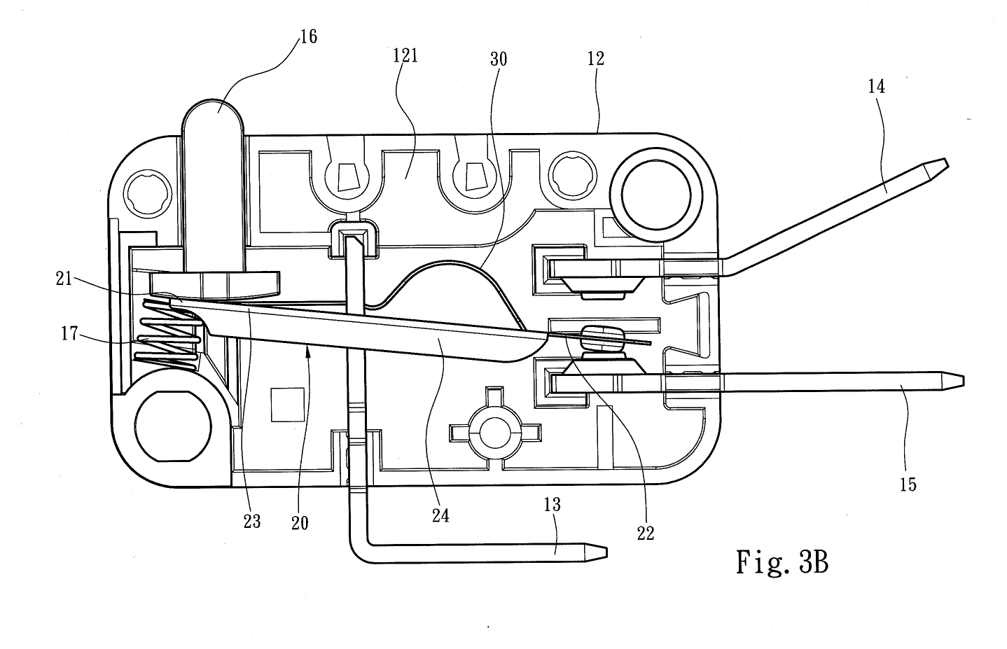

Refer to FIG. 3A and FIG. 3B. In the normal state, the pressing element 16 is not pressed down. Meanwhile, the spring 17 supports the pressed member 21 of the operating element 20 upward to push against the pressing element 16. Then, the elastic element 30 provides an elastic force to pull the conduction member 22 of the operating element 20 upward, whereby the conduction member 22 normally contacts the NC terminal 14, and whereby the common terminal 13 is electrically connected with the NC terminal 14 to form a first loop, as shown in FIG. 3A. When the pressing element 16 is pressed down, it pushes down the pressed member 21 of the operating element 20 to compress the spring 17. Then, the connection ribs 23 of the operating element 20 drive the conduction member 22 to descend, whereby the conduction member 22 is disconnected from the NC terminal 14 and connected with the NO terminal 15, and whereby the common terminal 13 is electrically connected with the NO terminal 15 to form a second loop, as shown in FIG. 3B. At this time, the downward pressure exerted on the operating element 20 is shared out to the elastic element 30, the extension member 25 and the spring 17. While the pressing force is released from the pressing element 16, the elastic element 30, the extension member 25 and the spring 17 jointly contribute the upward force to push the pressing element 16 upward.

In the present invention, the extension member 25 of the operating element 20 and the elastic element 30 connecting with the operating element 20 and the common terminal 13 jointly provide support force for the operating element 20 to prevent the operating element 20 from being fractured by repeated bendings, whereby the service life of the operating element 20 increases and the microswitch can endure more cycles of pressing activities.

The embodiments described are only to exemplify the present invention but not to limit the scope of the present invention. Any equivalent modification or variation according to the spirit of the present invention is to be also included within the scope of the present invention.

What is claimed is:

1. A microswitch enduring more cycles of pressing activities, comprising:
a casing including an accommodation room thereinside, a common terminal, a normally-closed terminal and a normally-open terminal that are extended from the accommodation room, and a pressing element;
an operating element including a holding hole to hold the common terminal, a pressed member located at one side of the common terminal and compressed by the pressing element, a conduction member located at another side of the common terminal and interposed between the normally-closed terminal and the normally-open terminal, two connection ribs connecting to the pressed member and the conduction member, and an extension member extending from the pressed member toward the common terminal; and
an elastic element which is arranged between the common terminal and the conduction member and includes a first fixing portion coupled to the common terminal and a second fixing portion coupled to the conduction member, wherein the operating element is normally supported by the elastic element to contact the normally-closed terminal and pushed down by the pressing element to disconnect from the normally-closed terminal and contact the normally-open terminal.

2. The microswitch enduring more cycles of pressing activities according to claim 1, wherein the extension member and one of the two connection ribs are spaced by a slot.

3. The microswitch enduring more cycles of pressing activities according to claim 1, wherein the two connection ribs are bent to form two support plates.

4. The microswitch enduring more cycles of pressing activities according to claim 1, wherein the common terminal includes a fixing hole to hold the first fixing portion of the elastic element.

5. The microswitch enduring more cycles of pressing activities according to claim 4, wherein one end of the extension member is inserted into the fixing hole of the common terminal.

6. The microswitch enduring more cycles of pressing activities according to claim 1, wherein the first fixing portion and the second fixing portion are latch hooks.

7. The microswitch enduring more cycles of pressing activities according to claim 1 further comprising a spring propping up the pressed member which is interposed between the pressing element and the spring.

8. The microswitch enduring more cycles of pressing activities according to claim 1, wherein the casing includes a base to hold the common terminal, the normally-closed terminal and the normally-open terminal, and a lid to cover the base.
